(19) United States
(12) Patent Application Publication
(10) Pub. No.: US 2013/0184970 A1
(43) Pub. Date: Jul. 18, 2013

(54) ENGINE REMOTE START CONTROL METHOD AND SYSTEM

(71) Applicant: Fadi S. Kanafani, Windsor (CA)

(72) Inventor: Fadi S. Kanafani, Windsor (CA)

(21) Appl. No.: 13/739,015

(22) Filed: Jan. 11, 2013

Related U.S. Application Data
(60) Provisional application No. 61/586,392, filed on Jan. 13, 2012.

(51) Int. Cl. F02D 35/00

(52) U.S. Cl. CPC F02D 35/00
USPC 701/103; 701/113

(57) ABSTRACT

A method is provided and may include monitoring operation of an engine of a vehicle, determining if the engine is started, and determining if the engine was started via an ignition or via a remote signal. The method may further include controlling operation of the engine at a first temperature if the engine was started via the ignition and controlling operation of the engine at a second temperature—different than the first temperature—if the engine was started via the remote signal. The second temperature may be higher than the first temperature to increase a temperature of coolant circulating within the engine.

### CROSS REFERENCE TO RELATED APPLICATION

This application claims the benefit of U.S. Provisional Ser. No. 61/586,392, filed Jan. 13, 2012.

### FIELD

The present disclosure relates to an engine control system and more particularly to an engine control system for use with a vehicle equipped with a remote starter.

### BACKGROUND

Modern vehicles may be equipped with a remote-start system that allows an operator to start the vehicle without actually having to be inside the vehicle. Such remote-start systems allow an operator to remotely start the vehicle in an effort to warm a passenger compartment thereof prior to the operator entering the vehicle. Warming the passenger compartment prior to occupant entry increases the comfort of the operator during cold-weather conditions, as the operator does not have to wait for the passenger compartment to be heated upon entry into the vehicle.

A remote-start system typically includes a transmitter such as a key fob and/or cellular phone that sends a start signal to the vehicle. Once received, an internal combustion engine of the vehicle is started and operates in the same manner as if the engine was started from within the passenger compartment via an ignition. In this state, the vehicle engine operates in an idle operating mode until either the operator enters the vehicle to actuate a transmission of the vehicle or the engine reaches a maximum idle time.

While conventional remote-start systems adequately start a vehicle engine, such systems do not typically cause the vehicle engine to operate in a different manner than if the vehicle engine were started from within the passenger compartment. Further, conventional remote-start systems do not cause the passenger compartment to be heated rapidly but, rather, simply operate the vehicle in an idle state and allow the passenger compartment to be heated as if the vehicle were started from within the passenger compartment.

### SUMMARY

A method is provided and may include monitoring operation of an engine of a vehicle, determining if the engine is started, and determining if the engine was started via an ignition or via a remote signal. The method may further include controlling operation of the engine at a first temperature if the engine was started via the ignition and controlling operation of the engine at a second temperature—different than the first temperature—if the engine was started via the remote signal. The second temperature may be higher than the first temperature to increase a temperature of coolant circulating within the engine.

In another configuration, a control system for a vehicle having an engine is provided. The control system may include a controller that controls the engine at a first temperature when the engine is started by an ignition located within a passenger compartment of the vehicle and at a second temperature—different than the first temperature—when the engine is started by remotely from the passenger compartment. The second temperature may be higher than the first temperature to increase a temperature of a coolant circulating within the engine.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 a schematic view of a vehicle in accordance with the present disclosure;

FIG. 2 is a perspective view of an instrument panel of the vehicle of FIG. 1;

FIG. 3 is a partial cross-sectional view of an engine of the vehicle in FIG. 1;

FIG. 4 is a schematic view of an engine, an engine cooling system, and an HVAC system of the vehicle of FIG. 1;

FIGS. 5A, 5B, and 5C are partial cross-sectional views of a cylinder of the engine of FIG. 3 during a first compression and power stroke;

FIGS. 6A and 6B are partial cross-sectional views of a cylinder of the engine of FIG. 3 during a delayed compression and power stroke;

FIGS. 7A and 7B are partial cross-sectional views of a cylinder of the engine of FIG. 3 during a first exhaust stroke and an intake stroke;

FIG. 8 is a graphical representation of exhaust valve and intake valve timing of the valves shown in FIGS. 7A and 7B;

FIGS. 9A, 9B, and 9C are partial cross-sectional views of a cylinder of the engine of FIG. 3 during a delayed exhaust stroke;

FIG. 10 is a graphical representation of exhaust valve and intake valve timing of the valves shown in FIGS. 9A, 9B, and 9C;

FIG. 11, is a flow chart detailing operation of an engine-control system in accordance with the present disclosure for use with a remote-start system; and

FIG. 12, is a flow chart detailing operation of an engine-control system in accordance with the principles of the present disclosure.

### DETAILED DESCRIPTION

As used here, the term module or controller refers to an Application Specific Integrated Circuit (ASIC), an electronic circuit, a processor (shared, dedicated, or group) and memory that executes one or more software or firmware programs, a combinational logical circuit, and/or suitable components that provide that provide the described functionality.

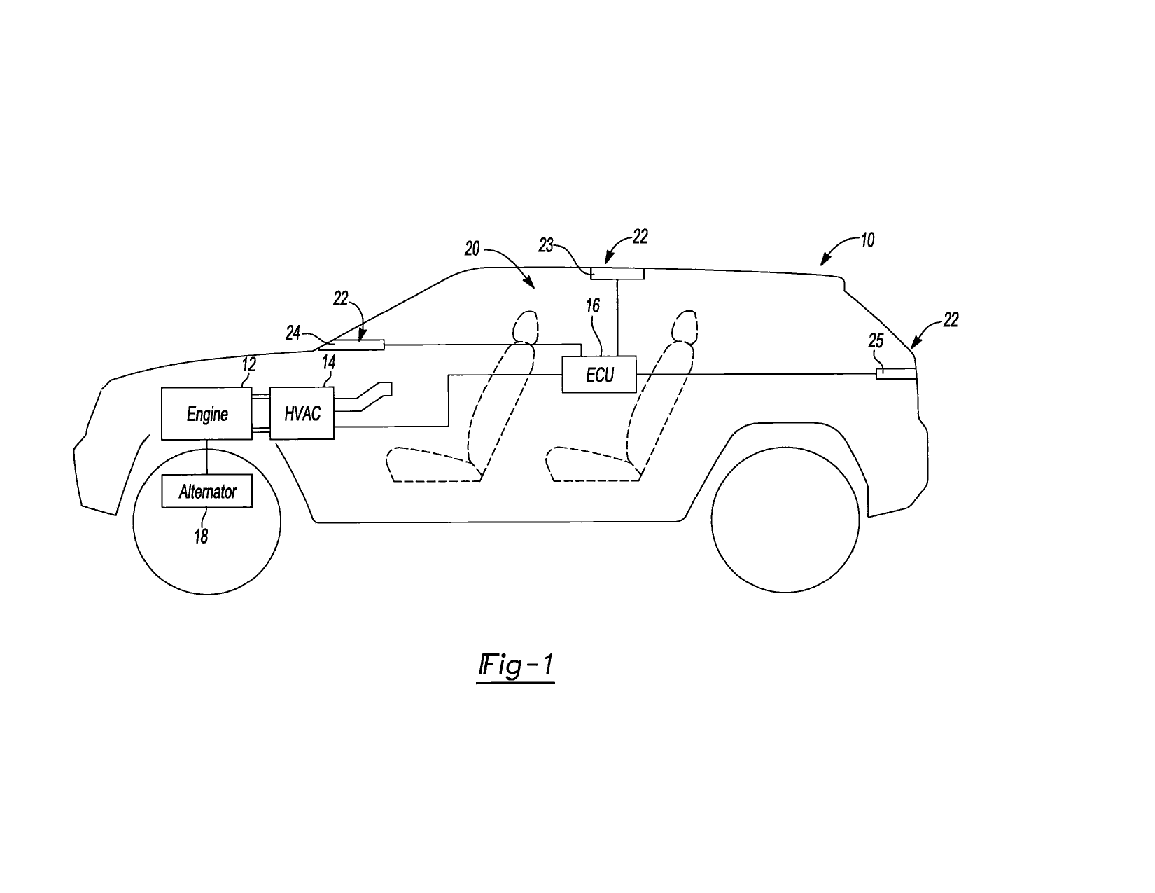

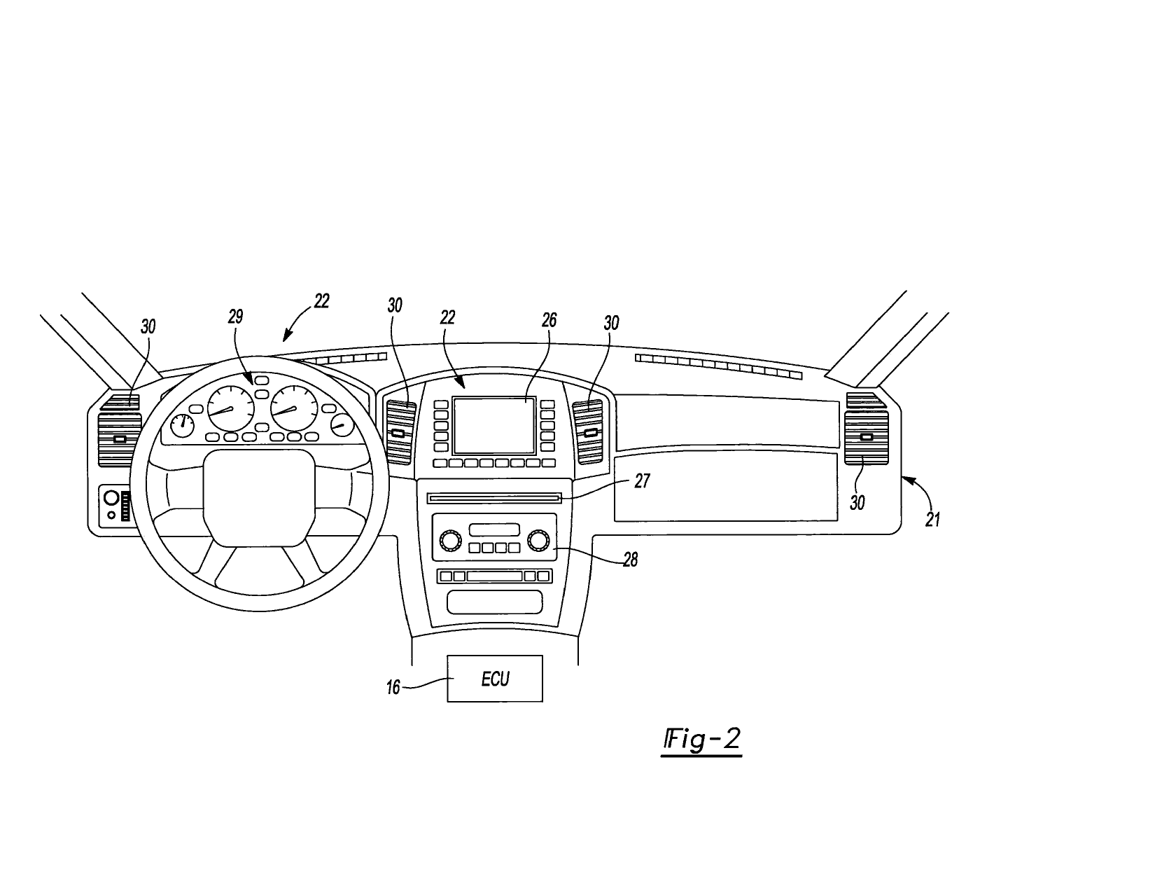

With reference now to FIGS. 1 and 2, a vehicle 10, is provided and may include an internal combustion engine 12, a heating, ventilating, and air conditioning (HVAC) system 14, an electrical control module (ECU) 16, and an alternator 18. The vehicle 10 may also include a passenger compartment 20 equipped with an instrument panel 21 and variety of electrical accessories 22. For example, the vehicle 10 may include a dome light 23, a front defroster 24, a rear defroster 25, a navigation and audio system 26, and a series of gages 29. The electrical accessories 22 may be controlled by the ECU 16, and may be powered by the alternator 18. The alternator 18 may convert mechanical energy from the engine 12 to electrical energy, which powers the electrical accessories 22. The passenger compartment 20 may also include a plurality of air vents 30 that transmit air from the HVAC system 14 into the passenger compartment 20.

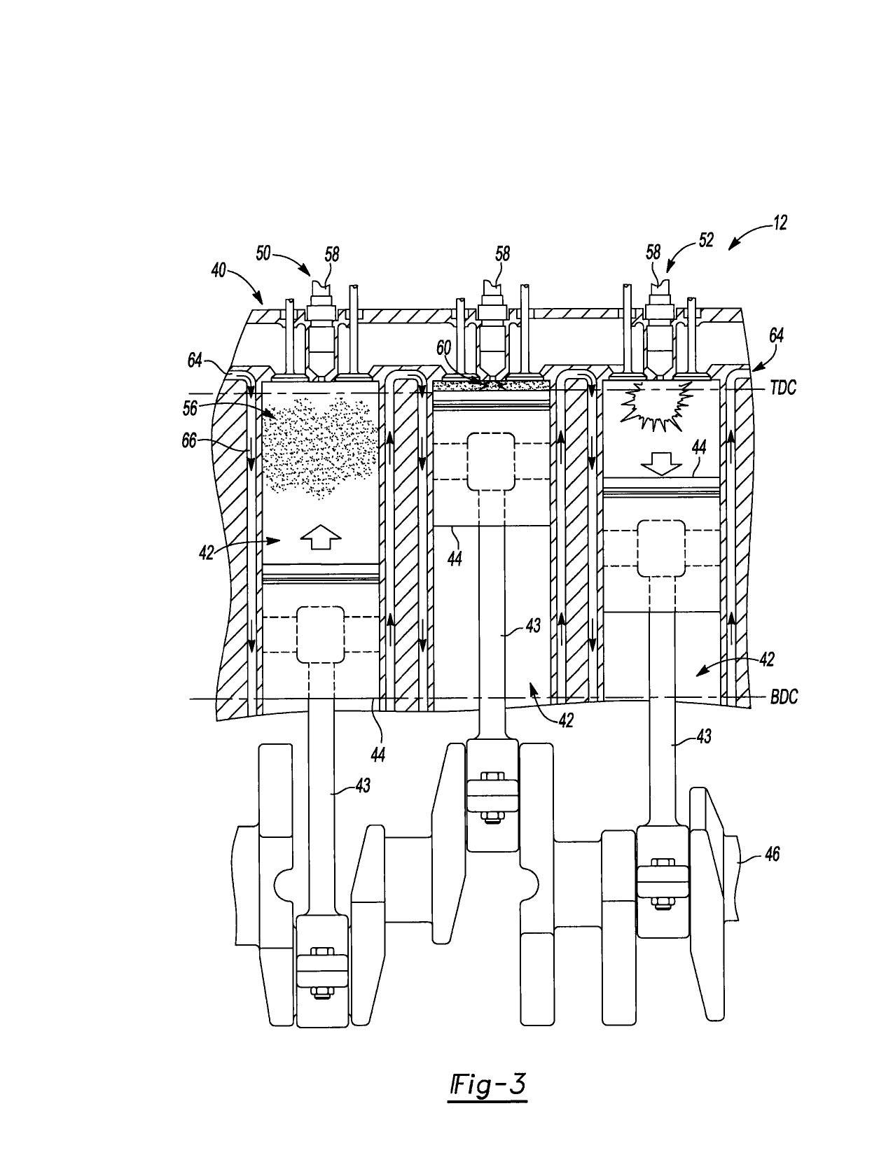

With particular reference to FIG. 3, the engine 12 is shown to include a cylinder block 40 that defines a plurality of cylinders or bores 42. Each cylinder 42 may slidably receive a piston 44 coupled to a crankshaft 46 to allow the piston 44 to move from the top to the bottom of the cylinder 42 or from the bottom to the top of the cylinder 42 to define an engine stroke. The top position of the piston 44 in the cylinder 42 may be referred to as the top dead center (TDC) and the bottom position of the piston 44 in the cylinder 42 may be referred to as bottom dead center (BDC). Again, movement of the piston 44 from the TDC to the BDC or movement of the piston 44 from the BDC to the TDC defines one engine stroke.

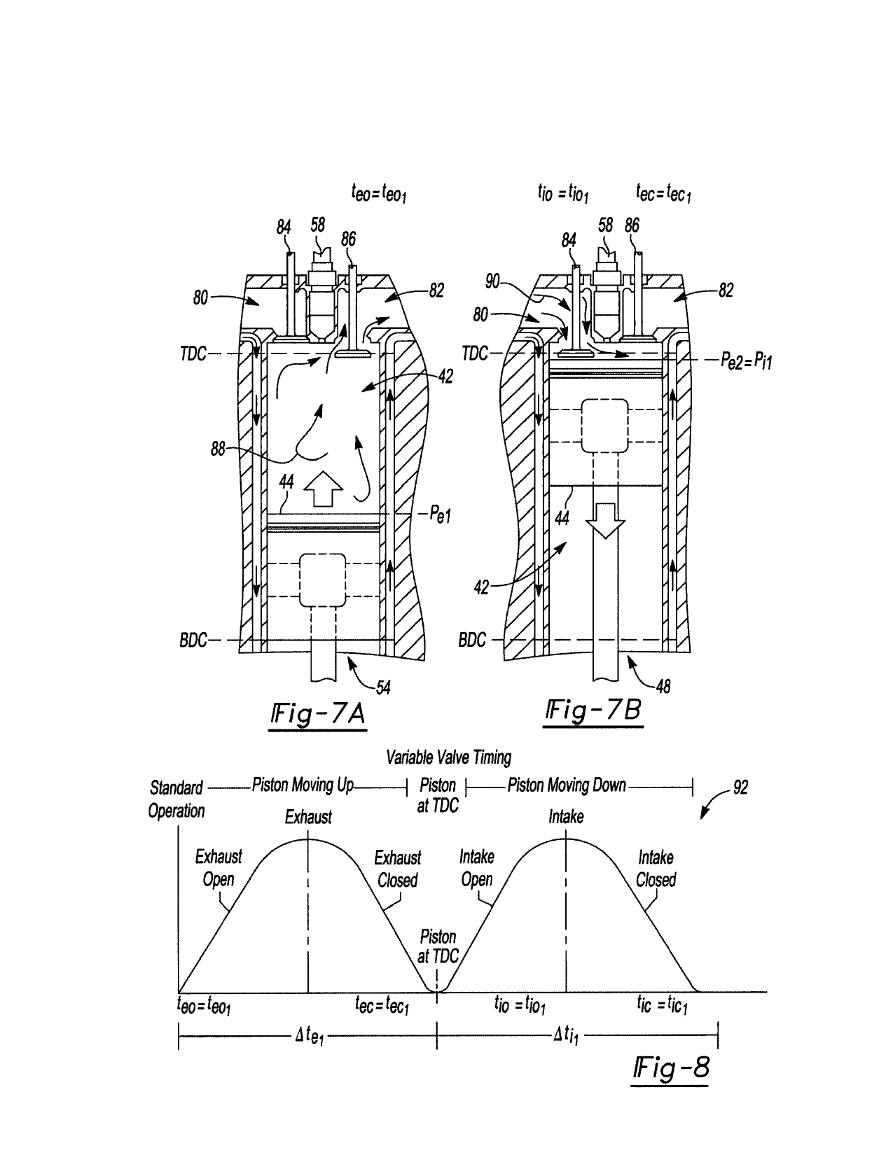

The engine 12 may be a four-stroke cycle engine having an intake stroke 48 (FIG. 7B), a compression stroke 50 (FIG. 3), a power stroke 52 (FIG. 3), and an exhaust stroke 54 (FIG. 7A). During operation of the compression stroke 50, the piston 44 starts at the BDC of the cylinder 42 and an air-fuel mixture 56 is sprayed into the cylinder 42. The piston 44 moves from the BDC towards the TDC and compresses the air fuel mixture 56.

The engine 12 may use a spark plug 58 to ignite the air-fuel mixture 56, thereby causing a spark 60 that ignites the compressed air-fuel mixture 56 to cause a combustion within the cylinder 42. The combustion moves the piston 44 towards the BDC within the cylinder 42 and, in so doing, generally defines the power stroke 52. During the power stroke 52, the piston 44 applies a force to a connecting rod 43 disposed between the piston 44 and the crankshaft 46, thereby causing rotation of the crankshaft 46 relative to the cylinder block 40.

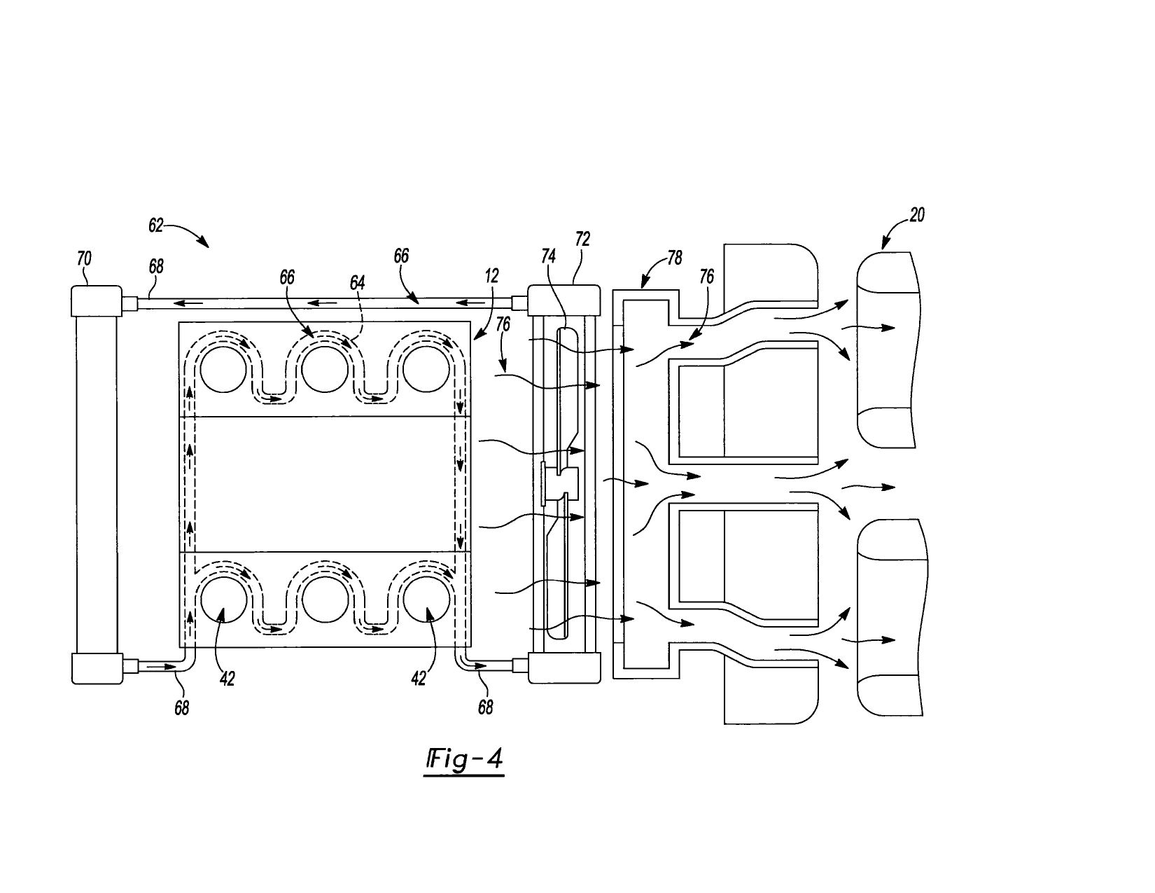

Combustion of the air-fuel mixture 56 generates a burning gas that may reach temperatures that exceed 1800 Degrees Fahrenheit (° F.). Some of the heat generated during combustion is absorbed by the cylinder block 40 and the piston 44 and, as a result, increases the overall temperature of the engine 12. The heat generated during combustion is removed from the engine 12 via an engine cooling system 62 (FIG. 4) to maintain a temperature of the engine 12 within a predetermined temperature range.

The engine cooling system 62 may maintain the temperature of the engine 12 within a predetermined temperature range that both protects the engine 12 and optimizes the efficiency of the engine 12. Namely, the engine cooling system 62 is designed to maintain the temperature of the engine 12 within a temperature range that both maximizes the efficiency of the engine 12 in generating energy to rotate the crankshaft 46 and protects the engine 12 and its components from overheating

The engine cooling system 62 may include a series of channels 64 formed in the cylinder block 40 proximate to the walls of the cylinder 42 (FIGS. 3 and 4). A coolant 66 may flow through the channels 64 of the cylinder block 40 to absorb heat caused by operation of the engine 12. The absorbed heat is directed away from the cylinders 42 as the coolant 66 circulates through the cylinder block 40, thereby cooling the cylinders 42 and pistons 44.

The coolant 66 may change phase from a liquid to a gas due to the rise in temperature caused by circulating within the channels 64 of the cylinder block 40. The gaseous coolant 66 may exit the cylinder block 40 via a series of hoses 68 and may be directed into a radiator 70 to allow the gaseous coolant 66 to change phase from a gas to a liquid. Specifically, the radiator 70 may include a series of serpentine tubes each having a fin extending therefrom (neither shown). The tubes and fins may be arranged to allow a stream of air to flow through the radiator 70 and contact the tubes and fins during forward movement of the vehicle 10 and/or during operation of a fan (not shown) disposed proximate to the radiator 70.

Interaction between the air and the radiator 70 allows the tubes and fins of the radiator 70 to reject heat from the coolant 66 disposed therein and into the air flowing through the radiator 70, thereby lowering the temperature of the coolant and causing the coolant 66 to change phase from a gas to a liquid. Once in the liquid phase, the coolant 66 may then flow back into the engine 12 to continue circulating through channels 64 in an effort to cool the cylinders 42 and pistons 44. As thus far described, the coolant 66—via channels 64 formed in the cylinder block 40—essentially absorbs heat from the cylinders 42 and pistons 44 caused by combustion during operation of the engine 12 and directs this heat away from the cylinders 42 and pistons 44 by transferring the heat to the air flowing through the radiator 70.

With particular reference to FIG. 4, the HVAC system 14 is shown as utilizing heat from the engine 12 to increase a temperature within the passenger compartment 20. The HVAC system 14 may direct heat from the engine 12 towards the passenger compartment 20 by incorporating a heater core 72 and a fan 74.

In operation, the fan 74 may draw air 76 across the heater core 72, thereby allowing the air 76 to absorb heat from the coolant 66 as the coolant 66 travels within the heater core 72. As with the radiator 70, the heater core 72 may likewise include a series of serpentine tubes and associated fins (neither shown) to increase the ability of the heater core 72 in rejecting heat from the coolant 66. The warm air 76 exiting the heater core 72 may flow into a series of air ducts 78 that channel the warm air 76 into the air vents 30 located in the passenger compartment 20 of the vehicle 10, thereby increasing the temperature of the passenger compartment 20.

Thus far, the engine cooling system 62 and HVAC system 14 have been described as cooperating to remove heat from the engine 12 and to direct at least a portion of the removed heat into the passenger compartment 20. The heat is removed from the engine 12 via the engine cooling system 62 and is then rejected both at the radiator 70 and at the heater core 72. The heat rejected at the heater core 72 is directed into the passenger compartment 20 via air ducts 78 and air vents 30 under force of the fan 74 to allow the HVAC system 14 to heat the passenger compartment 20.

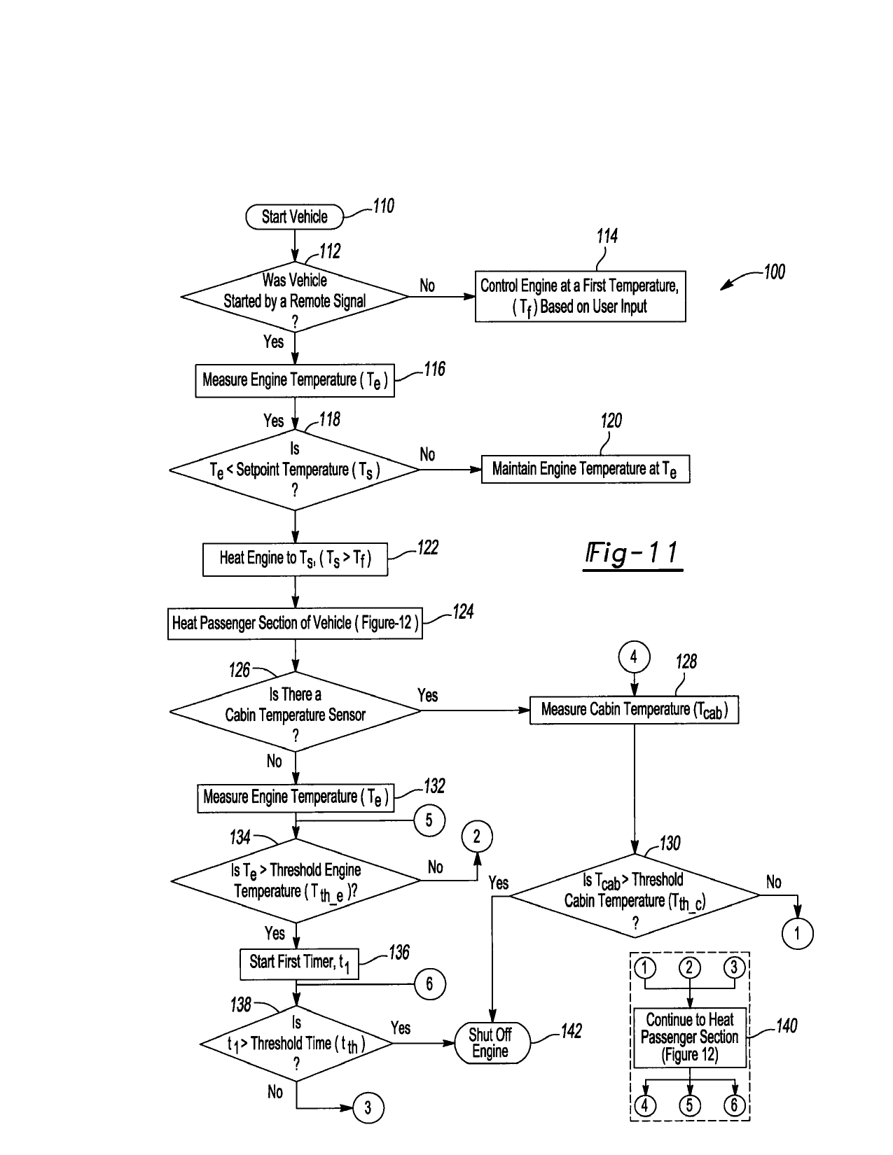

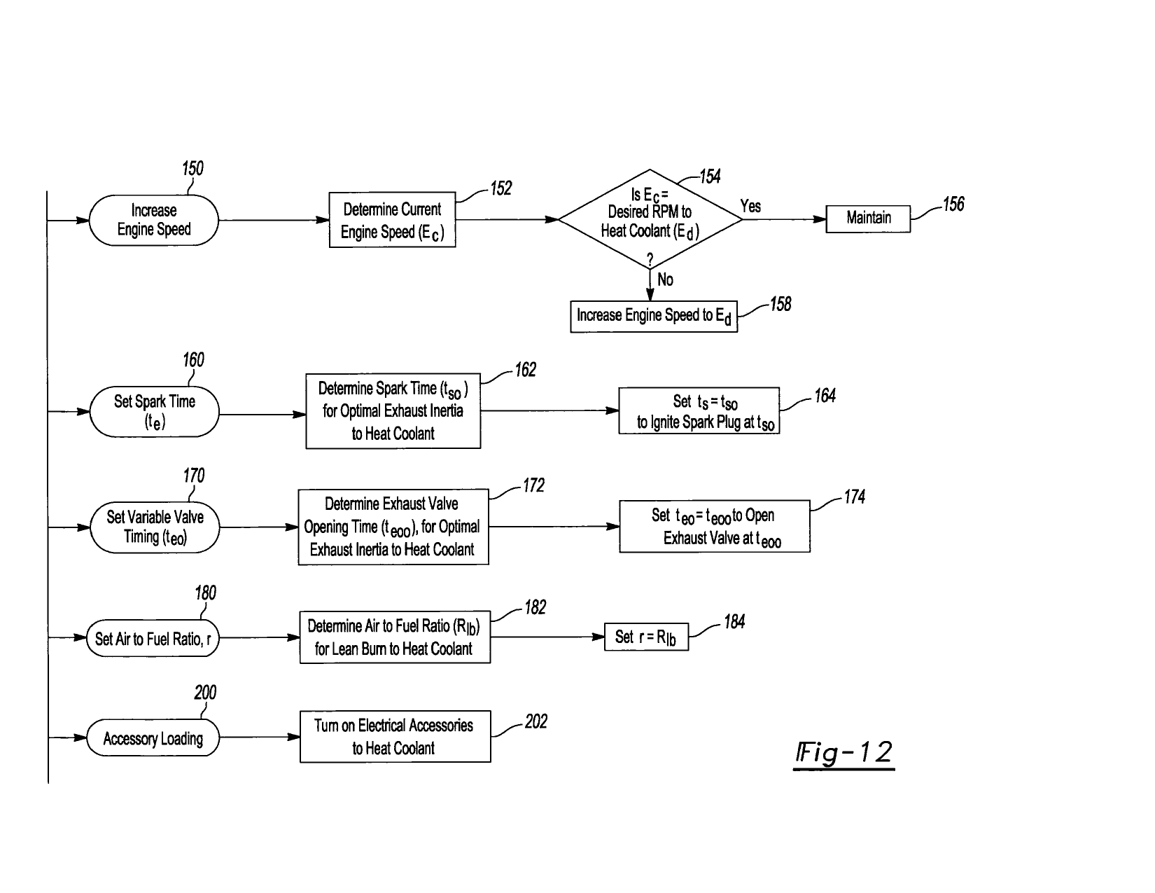

The ECU 16 may receive information from and control operation of the engine 12, the engine cooling system 62, the HVAC system 14, and the electrical accessories 22 and may do so based at least in part on how the engine 12 was started. Specifically, the ECU 16 may control the engine 12 and, thus, the engine cooling system 62 and HVAC system 14 based on whether the engine 12 was started remotely or, alternatively, whether the engine 12 was started from within the passenger compartment 20. Based on the information received, the ECU 16 may use a series of algorithms (FIGS. 11 and 12) to determine the operating parameters of the vehicle 10 and may control the following operating parameters independently from or in conjunction with one another: spark time (tₛ), exhaust-valve timing and/or intake-valve timing, air-fuel ratio (r) of the air-fuel mixture, the speed of the engine 12, and/or accessory loading.

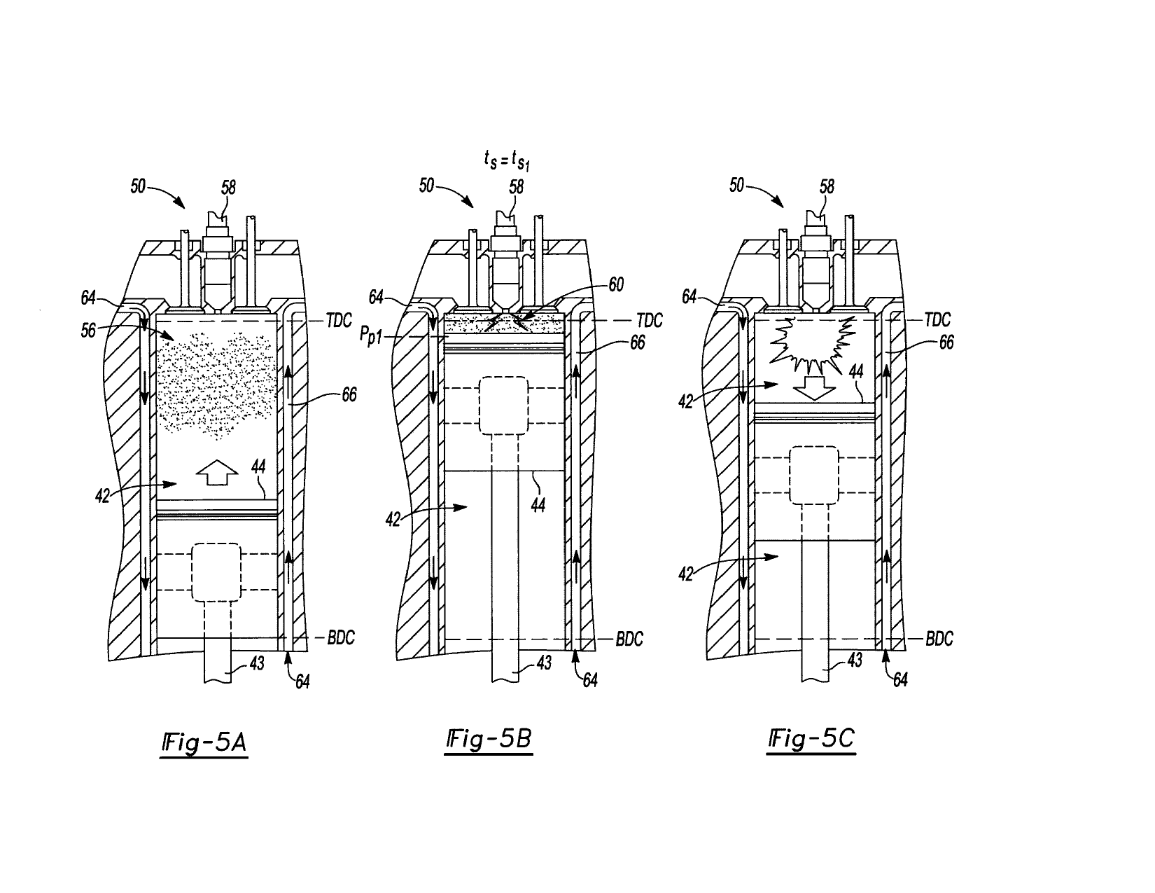

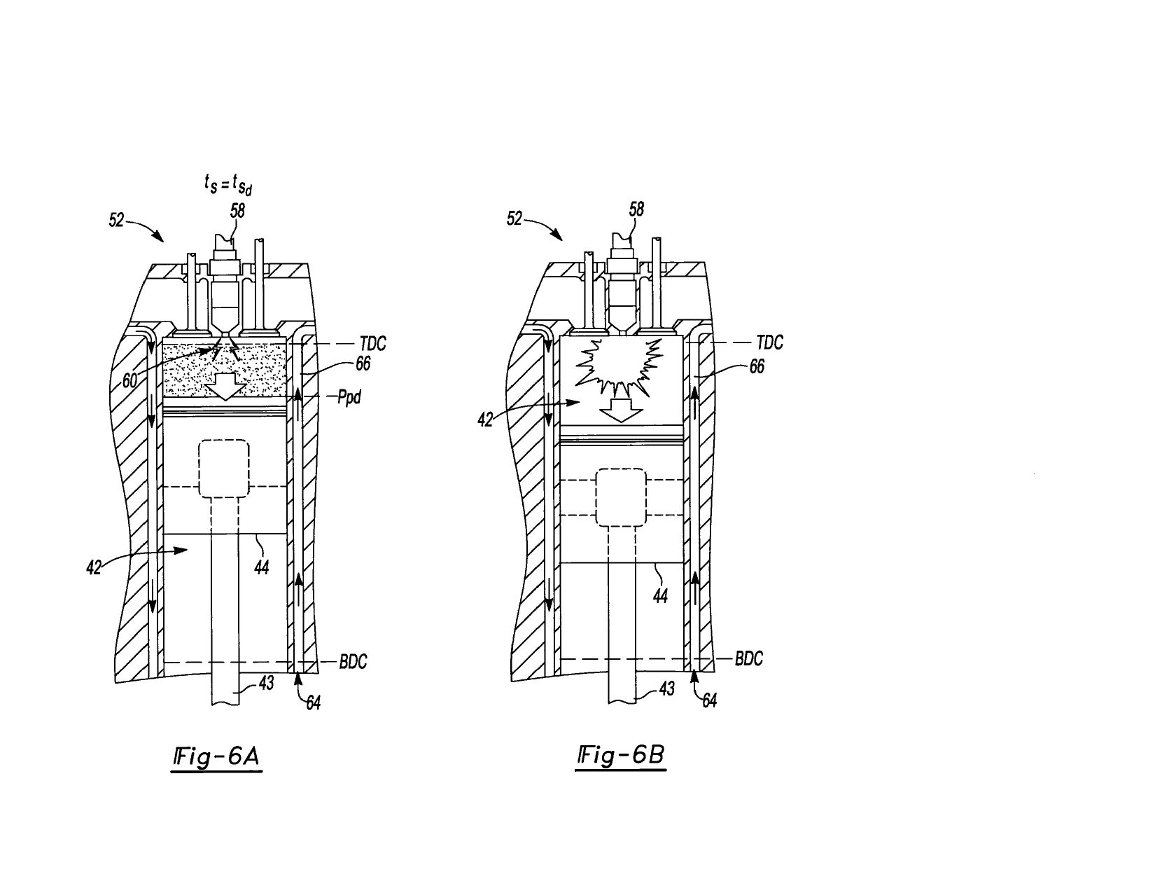

With particular reference to FIGS. 5A-5C and 6A-6B, controlling of the spark time (tₛ) will be described in detail. Timing or spark time (tₛ) is the process of setting the time that the spark 60 occurs in the cylinder 42 relative to the position of the piston 44 within the cylinder 42 and the angular velocity of the crankshaft 46. The ECU 16 controls the timing of the spark 60 based on various operating parameters, which may include the speed and/or the load on the engine 12. As shown in FIG. 5B, the ECU 16 (not shown) may set the spark time (tₛ) to a first spark time (tₛ₁) at a first power stroke position (pₚ₁). As mentioned earlier, during the compression stroke 50, the piston 44 travels up the cylinder 42 and compresses the air-fuel mixture 56 (FIG. 5A). Once it reaches (pₚ₁), which may be some time after the piston 44 reaches the TDC of the cylinder 42, the spark plug 58 will generate the spark 60 at (tₛ₁) and a combustion may occur to push the piston 44 down the cylinder 42 (FIGS. 5B and 5C). At (tₛ₁) and (pₚ₁), the piston 44 is able to utilize the full force of the combustion to push the piston 44 down and rotate the crankshaft 46, as the spark 60 occurs when the piston 44 is closest to the TDC of the cylinder 42. The spark time (tₛ) illustrated in FIGS. 5A-5C results in the heat from the combustion being primarily absorbed by the piston 44, as the piston 44 is close to the TDC of the cylinder 42 during combustion. Further, relatively little heat is absorbed by the cylinder 42, as the majority of the cylinder 42 is concealed behind the piston 44 and is shielded by the piston 44 during combustion.

The ECU 16 may adjust the spark time (tₛ) to a delayed spark time (t_{sd}) when the piston 44 is at a delayed power stroke position (p_{pd}), as shown in FIGS. 6A-6B. At the delayed power stroke position (p_{pd}), the piston 44 is already moving down the cylinder 42 toward the BDC of the cylinder 42 when the spark plug 58 generates the spark 60 at (t_{sd}) where (tₛ₁)<(t_{sd}). The energy from the combustion assists in pushing the piston 44 down. However, some of the energy is not used to act on the piston 44 and simply generates heat, which may be absorbed by the cylinder 42 and piston 44. The excess heat caused by altering the sparking timing (tₛ) is primarily absorbed by the cylinder 42, as more of the cylinder 42 is exposed during the combustion as compared to the combustion at (tₛ₁, pₚ₁).

With particular reference to FIGS. 7A and 7B, the cylinder block 40 may include an intake port 80 and an exhaust port 82 at each cylinder 42. An intake valve 84 may be used to selectively seal the intake port 80 and an exhaust valve 86 may be used to selectively seal the exhaust port 82. At the end of the power stroke 52 and at the beginning of the exhaust stroke 54, the piston 44 maybe at the BDC and the cylinder 42 may contain a hot gas or an exhaust 88 that consists mainly of carbon dioxide and water. The exhaust valve 86 may move into the cylinder 42 in order to unseal the exhaust port 82 (FIG. 7A).

As the piston 44 moves up the cylinder 42 towards the TDC, the exhaust 88 is pushed into the exhaust port 82 (FIG. 7A). Once the piston 44 reaches the TDC, which is the end of the exhaust stroke 54 and at the start of the intake stroke 48, the exhaust valve 86 may retract into the exhaust port 82 to seal the exhaust port 82 and the intake valve 84 may extend into the cylinder 42 to open the intake port 80. As the piston 44 moves down the cylinder 42 and toward the BDC, a vacuum is created in the cylinder 42 and a stream of air 90 from the intake port 80 moves into the cylinder 42 (FIG. 7B). Once the piston 44 reaches the BDC, the intake valve 84 may retract into the intake port 80 to seal the intake port 80 and the piston 44 continues with the compression stroke 50 to continue the four-stroke cycle.

The ECU 16 may control the actuation of the intake valve 84 and/or exhaust valve 86 in order to control the movement of air into and out of the cylinder 42. For example, the ECU 16 may set an exhaust valve open time (tₑₒ), an exhaust valve close time (t_{ec}), an intake valve open time (tᵢₒ), and an intake valve close time (t_{ic}).

FIG. 8 depicts a graphical representation of a first valve actuating time 92 of the exhaust valve 86 and intake valve 84 shown in FIGS. 7A and 7B. The exhaust valve 86 may be opened at (tₑₒ₁) and may be closed at (t_{ec1}) for a time period of (Δₑ₁) where the ECU 16 sets (tₑₒ)=(tₑₒ₁) and (t_{ec})=(t_{ec1}). The intake valve 84 may be open at (tᵢₒ₁) and may be closed at (t_{ic1}) for a time period of (Δtᵢ₁), where the ECU 16 sets (tᵢₒ)=(tᵢₒ₁)=(tᵢₒ₁), (t_{ic})=(t_{ic1}).

In FIG. 7A, when the exhaust valve 86 opens at (tₑₒ₁), the piston 44 may be at a first exhaust stroke position (pₑ₁) which may be at the BDC. In FIG. 7B, as the piston 44 reaches TDC, which may be a second exhaust stroke position (pₑ₂), the exhaust valve 86 closes at (t_{ec1}). When the intake valve 84 opens at (tᵢₒ₁), the piston 44 may be at first intake stroke position (pᵢ₁) where (p_{H}) maybe equal to (pₑ₂), since once the piston 44 reaches TDC, it is at the end of the exhaust stroke 54 and the start of the intake stroke 48. When the piston 44 reaches the BDC, the intake valve 84 closes at (t_{ic1}) and the compression stroke 50 begins.

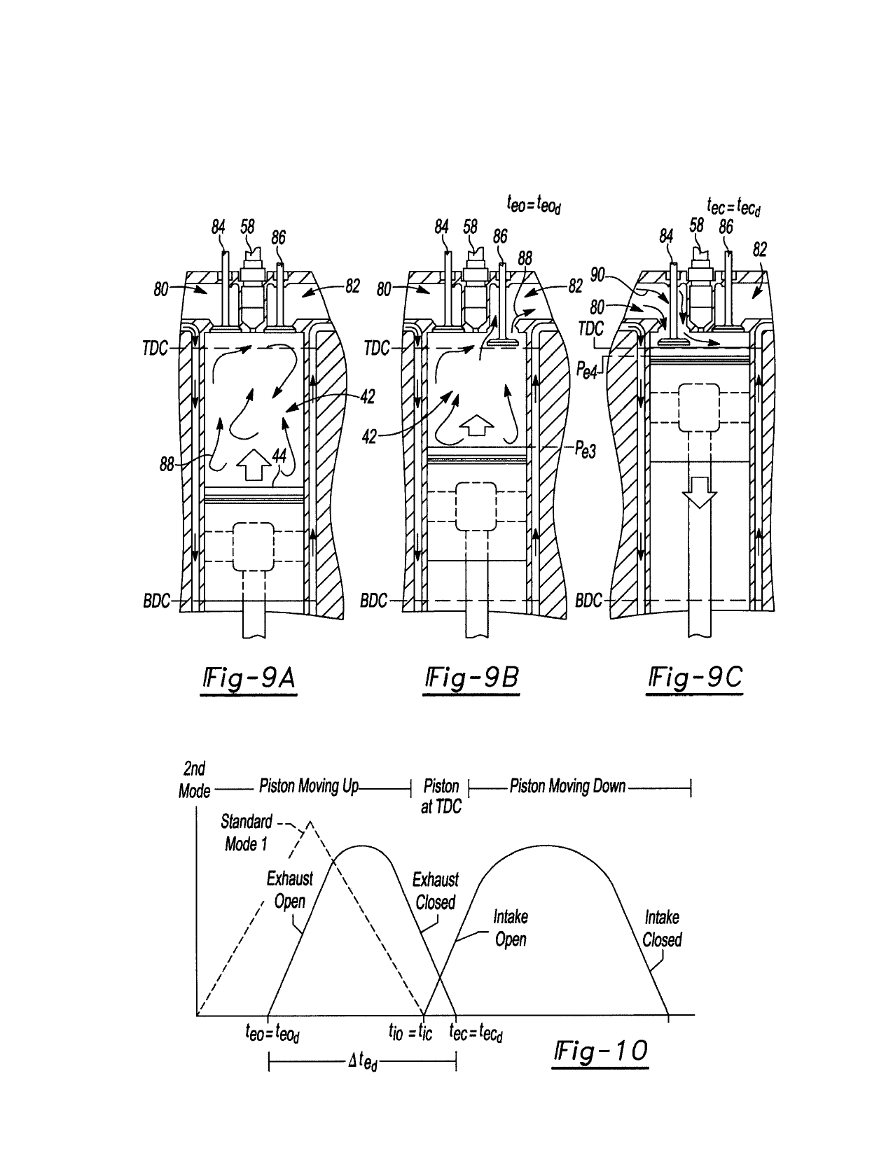

The time period in which the exhaust port 82 and intake port 80 are open or closed may be modified by the ECU 16. For example, FIG. 10 depicts a graph that reflects a delayed valve actuating time 94. The exhaust valve 86 may open at a delayed time (t_{eod}) and closed at (t_{ecd}) for a time period of (Δt_{ed}) where the ECU 16 sets (tₑₒ)=(t_{eod}) and (t_{ec})=(t_{ecd}). In FIG. 9A, the exhaust valve 86 remains closed when the piston 44 is at (pₑ₁). As the piston 44 moves up the cylinder toward the TDC, the hot exhaust 88 remains in the cylinder 42 and the walls of the cylinder 42 continue to absorb the heat from the exhaust 88. In FIG. 9B, the exhaust valve 86 opens at a third exhaust stroke piston position (pₑ₃) where (pₑ₃) may be after (pₑ₁) but before (pₑ₂), which is near the TDC (FIG. 7B). Once the exhaust valve 86 opens, the hot exhaust 88 is pushed out of the cylinder 42 and into the exhaust port 82. In FIG. 9C, once the piston 44 reaches a fourth exhaust stroke piston position (pₑ₄), where (pₑ₄) may equal to (pₑ₂), the exhaust valve 86 closes at (t_{ecd}) and the intake port 80 opens at (tᵢₒ). The actuation time of the intake valve 84 could similarly be modified by the ECU 16 to maximize the amount of time the exhaust gas 88 spends within each cylinder 42 prior to being expelled in an effort to raise a temperature of the cylinders 42 and, thus, a temperature of the coolant 66 circulating within the passages 64.

The vehicle 10 may be started by an ignition (i.e., a key, a push button, etc.) from within the passenger compartment 20 or, alternatively, may be started via a remote-start system, whereby the remote-start system sends a remote-start signal to the vehicle 10 via a key fob or cellular phone (neither shown). The ECU 16 may modify the operation of the engine 12 depending on whether the vehicle 10 was started by the ignition within the passenger compartment 20 or via a remote-start signal.

With reference to FIG. 11, the ECU 16 may perform an algorithm 100 to warm the passenger compartment 20 of the vehicle 10 if the vehicle 10 was started by a remote-start signal. Initially, the ECU 16 may receive information that the vehicle 10 is running at step 110. The ECU 16 then determines whether the vehicle 10 was started by the remote-start signal at 112. The ECU 16 may determine the vehicle 10 was remotely started based on whether the start signal was received from an ignition of the vehicle 10 or from a remote device such as a key fob or cell phone (neither shown). If the vehicle 10 was not started by a remote-start signal, the ECU 16 will continue to control the engine 12 at a first temperature (T_{f}) based on a user input at 114. In so doing, the spark time (tₛ) may be set to the first spark time (tₛ₁) and the valve actuating time maybe set to the first valve actuating time for the exhaust and intake valve 92.

With continued reference to FIG. 11, if the vehicle 10 was started remotely, the ECU 16 may measure the current temperature of the engine 12 (Tₑ) at 116. Once (Tₑ) is received, the ECU 16 compares (Tₑ) to a setpoint temperature (Tₛ) at 118. In one configuration, the setpoint temperature (Tₛ) is a reference temperature determined by the manufacturer and stored in the ECU 16, for example.

If (Tₑ)≧(Tₛ), the ECU 16 will maintain the temperature of the engine 12 at (Tₑ) at 120. If (Tₑ)<(Tₛ), the ECU 16 will continue to steps 122 and 124 to heat the engine 12 to (Tₛ) in an effort to rapidly heat the passenger compartment 20 of the vehicle 10.

The ECU 16 may modify operation of the engine 12 to quickly increase the temperature of the coolant 66 flowing through the engine 12 and, in so doing, rapidly increase a temperature of the passenger compartment 20. For example, the ECU 16 may increase engine speed at 150, may adjust the spark time (tₛ) at 160, may adjust the valve actuating time at 170 (see, for example, FIG. 10), may adjust the air-to-fuel ratio (r) at 180, and may adjust accessory loading at 200. Any one or all of the foregoing steps 150, 160, 170, 180, 200 may be employed in an effort to quickly raise a temperature of the coolant 66 by increasing an operating temperature of the engine 12 and, thus, the temperature of the coolant 66 circulating through the heater core 72.

The ECU 16 may increase the speed of the engine 12 at 150 to increase the friction within the cylinder blocks 40, thereby raising a temperature of each cylinder 42. After the vehicle 10 is started but before the vehicle 10 is moving, the engine 12 may operate substantially at 700-1200 revolutions per minute (RPM). The ECU 16 may measure the current speed of the engine (E_{c}) 12 at 152 and may compare the engine speed (E_{c}) to a desired RPM (E_{d}) at 154. The desired RPM (E_{d}) may be around 2000 RPM and may be determined by the manufacturer as the speed of the engine 12 that more rapidly heats the coolant 66 when compared to engine operation at 700-1200 RPM. If (E_{c}) equals (E_{d}), the ECU 16 may maintain the speed of the engine 12 to (E_{d}) at 156. Alternatively, if (E_{c}) does not equal (E_{d}), the ECU 16 may increase the speed of the engine 12 to (E_{d}) at 158. Increasing the speed of the engine 12 increases the number of combustions within the cylinders 42 for a given time period, thereby increasing the heat generated by the engine 12. The additional heat generated by the engine 12 increases a temperature of the coolant 66, which allows the heater core 72 to more rapidly heat the passenger compartment 20.

The ECU 16 may additionally or alternatively adjust the spark time (tₛ) in the cylinders 42 at 160, as previously discussed with respect to FIGS. 5A-5C and 6A-6B in an effort to generate more heat during engine operation. For example, the ECU 16 may determine an optimal burn spark time (tₛₒ) and a correlating power stroke position (pₚₒ) at 162, where (tₛ₁)<(tₛₒ) and (pₚₒ) is a position sometime after (pₚₛ₁). By setting (tₛ) to (tₛₒ) in step 164, the spark plug 58 will generate the spark 60 at (tₛₒ) and the resulting combustion may be optimally utilized to heat the walls of the cylinder 42. At (pₚₒ) the piston 44 may already be moving down the cylinder 42, which may be similar to delay time (t_{sd}) and the correlating power stroke position (p_{pd}) (FIGS. 5D and 5E). The process 100 may determine (tₛₒ) and (pₚₒ) through a series of algorithms or, alternatively, the value of (tₛₒ) and (pₚₒ) may be preset in the ECU 16.

The ECU 16 may continue to heat the engine 12 and the coolant 66 by proceeding to step 170, whereby the ECU 16 sets the open exhaust valve time (tₑₒ). As discussed earlier with respect to FIGS. 7A-7B, 8, 9A-9C, and 10, the ECU 16 may allow the cylinder 42 to absorb more heat from the exhaust 88 by determining an optimal time to open the exhaust valve 86 (tₑₒₒ). For example, the ECU 16 may determine an optimal exhaust inertia to heat the coolant 66 at 172 and may set (tₑₒ) equal to (tₑₒₒ) at 174, where (t_{eod}), (tₑₒₒ)>(tₑᵥ₁), and the exhaust valve opening occurs at a exhaust stroke position (pₑₒ), which is later than (pₑ₁) but before (pₑ₂).

The ECU 16 may also adjust the air-to-fuel ratio (r) of the air-fuel mixture 56 sprayed into the cylinder 42. When the engine 12 is controlled at (T_{f}), the air-to-fuel ratio (r) may be equal to a standard vehicle operating ratio (Rₛₒ). At (Rₛₒ), the ratio of air to fuel may be optimal for the purpose of operating the vehicle 10 based on user input. However, when the ECU 16 determines that the vehicle 10 was started remotely at 112, the ECU 16 may adjust the air-to-fuel ratio for the purpose of providing the engine 12 with a leaner burn to operate the engine 12 at a higher temperature and direct more heat to the coolant 66. An adjusted air-to-fuel ratio (r) may be referred to as (R_{lb}) and may consist of less fuel and more air than at (Rₛₒ). Modifying the air-to-fuel ratio (r) in such a fashion causes more heat to be generated during combustion and therefore increases a temperature of each cylinder 42 and the coolant 66 circulating within the cylinder block 40. The ECU 16 may set the air-to-fuel ratio (r) to (R_{lb}) at 184.

The ECU 16 may create additional heat within the passenger compartment 20 by increasing the load on the engine 12. For example, the ECU 16 may increase the accessory load at 200 by turning on the electrical accessories 22 at 202. Specifically, the ECU 16 may turn on the dome light 23, the front defroster 24, the rear defroster 25, the navigation and audio system 26, and the gauges 29. Turning on the accessories 22 causes the alternator 18 to generate additional energy to power the various accessories 22. In so doing, the alternator 18 requires additional mechanical energy from the engine 12, which places an increased load on the engine 12. As a result, the engine 12 is required to increase its output in order to provide enough energy to the alternator 18, which causes the temperature of the engine 12 and, thus, the coolant 66 to increase.

With reference to FIG. 11, the ECU 16 determines whether the steps (150, 160, 170, 180, 200) set forth in FIG. 12 have caused the passenger compartment 20 to heat up. The ECU 16 first determines if the vehicle 10 includes a temperature sensor in the passenger compartment 20 at 126. If the vehicle 10 includes a temperature sensor, the ECU 16 measures the current passenger-compartment temperature (T_{cab}) at 128 and compares the measured temperature to a threshold cabin temperature (Tₜₕ_{_{—}}_{c}) at 130. The threshold cabin temperature may be set by the manufacturer or, alternatively, may be input by the user. In any event, if (T_{cab}) is less than (Tₜₕ_{_{—}}_{c}), the ECU 16 will continue to heat the passenger compartment 20 per the modified engine parameters described above (FIG. 12) at 140. The ECU 16 will continue this cycle until (T_{cab}) is greater than (Tₜₕ_{_{—}}_{c}). Once (T_{cab}) is greater than (Tₜₕ_{_{—}}_{c}), the passenger compartment 20 is fully heated to the desired temperature and the ECU 16 will proceed to step 142 where the engine 12 may be shut off.

If the vehicle 10 does not include a temperature sensor in the passenger compartment 20, the ECU 16 measures the temperature of the engine 12 (Tₑ) at 132 and compares (Tₑ) to a threshold engine temperature (Tₜₕ_{_{—}}ₑ) at 134. If (Tₑ) is less than (Tₜₕ_{_{—}}ₑ), the ECU 16 will continue to heat the passenger compartment 20 per the modified engine parameters described above (FIG. 12) at 140. The process 100 will continue this cycle until (Tₑ) is greater than (Tₜₕ_{_{—}}ₑ). Once (Tₑ) is greater than (Tₜₕ_{_{—}}ₑ), the ECU 16 determines that the engine 12 has reached its threshold temperature and initiates a first timer (t₁) at 136. In order to ensure that the passenger compartment 20 is heated, the engine 12 continues to run for a set threshold time (tₜₕ). If (t₁) is less than (tₜₕ), the ECU 16 will continue to heat the passenger compartment 20 per the modified engine parameters described above (FIG. 12) at 140. The ECU 16 continues to track time (t₁) until (t₁) is greater than or equal to (tₜₕ). Once (t₁) is greater than or equal to (tₜₕ), the ECU 16 turns off the engine 12 at 142.

What is claimed is:

1. A method comprising:
monitoring operation of an engine of a vehicle;
determining if said engine is started;
determining if said engine was started via an ignition or via a remote signal;
controlling operation of said engine at a first temperature if said engine was started via said ignition; and
controlling operation of said engine at a second temperature, different than said first temperature, if said engine was started via said remote signal, said second temperature being higher than said first temperature to increase a temperature of coolant circulating within said engine.

2. The method of claim 1, wherein said controlling operation of said engine at said second temperature increases a temperature of coolant circulating within said engine and to an HVAC system of said vehicle.

3. The method of claim 1, wherein said controlling operation of said engine at said second temperature includes controlling a spark-plug timing.

4. The method of claim 3, wherein said controlling said spark timing includes initiating a spark in said engine at a later time during a stroke of said engine when compared to operating said engine at said first temperature.

5. The method of claim 1, wherein said controlling operation of said engine at said second temperature includes controlling at least one of an exhaust valve and an intake valve of said engine.

6. The method of claim 5, wherein said controlling said exhaust valve includes maintaining said exhaust valve in a closed position for a greater period of time during a stroke of said engine when compared to operating said engine at said first temperature.

7. The method of claim 1, wherein said controlling operation of said engine at said second temperature includes setting an air-to-fuel ratio of an air-fuel mixture to a leaner air-to-fuel ratio when compared to operating said engine at said first temperature.

8. The method of claim 1, wherein said controlling operation of said engine at said second temperature includes increasing a speed of said engine.

9. The method of claim 1, wherein said controlling operation of said engine at said second temperature includes turning on electrical accessories of said vehicle.

10. The method of claim 1, wherein said controlling operation of said engine at said second temperature includes controlling a spark timing, controlling exhaust-valve timing, adjusting an air-to-fuel ratio of an air-fuel mixture supplied to said engine, increasing a speed of said engine, and turning on electrical accessories of said vehicle.

11. A control system for a vehicle having an engine, the control system comprising:
a controller operable to control the engine at a first temperature when the engine is started by an ignition located within a passenger compartment of the vehicle and at a second temperature, different than said first temperature, when the engine is started by remotely from said passenger compartment, said second temperature being higher than said first temperature to increase a temperature of a coolant circulating within the engine.

12. The control system of claim 11, wherein said controller operates the engine at said second temperature to increase a temperature of said coolant circulating within the engine and to an HVAC system of the vehicle.

13. The control system of claim 11, wherein said controller adjusts a spark-plug timing when operating at said second temperature.

14. The control system of claim 11, wherein said controller adjusts an opening of at least one of an exhaust valve and an intake valve when operating at said second temperature.

15. The control system of claim 11, wherein said controller increases a speed of the engine when operating at said second temperature.

16. The control system of claim 11, wherein said controller adjusts an air-to-fuel ratio when operating at said second temperature.

17. The control system of claim 11, wherein said controller actuates at least one electrical accessory of the vehicle when operating at said second temperature to increase a load experience by an alternator of the vehicle.

18. The control system of claim 11, wherein said controller is responsive to a temperature sensor disposed within said passenger compartment.

19. The control system of claim 11, wherein said controller turns off the engine if the engine runs for a predetermined time at said second temperature.

20. The control system of claim 11, wherein controller adjusts a spark-plug timing, adjusts an opening of at least one of an exhaust valve and an intake valve, increases a speed of the engine, adjusts an air-to-fuel ratio when operating at said second temperature, and actuates at least one electrical accessory of the vehicle when operating at said second temperature.
